(19) United States
(12) Patent Application Publication
(10) Pub. No.: US 2025/0077555 A1
(43) Pub. Date: Mar. 6, 2025

(54) SYSTEM AND METHOD FOR MULTI-STAGE PROCESSING OF USER QUERY FOR ENHANCED INFORMATION RETRIEVAL

(71) Applicant: Quantiphi, Inc, Marlborough, MA (US)

(72) Inventors: Dagnachew Birru, Marlborough, MA (US); Saisubramaniam Gopalakrishnan, Mumbai (IN); Muneeswaran I, Mumbai (IN); Rohit Agrawal, Mumbai (IN); Vishal Vaddina, Mumbai (IN)

(73) Assignee: Quantiphi, Inc, Marlborough, MA (US)

(21) Appl. No.: 18/457,607

(22) Filed: Aug. 29, 2023

(51) Int. Cl. G06F 16/33; G06F 16/338; G06F 40/211

(52) U.S. Cl. CPC G06F 16/3338; G06F 16/338; G06F 40/211

(57) ABSTRACT

A method for multi-stage processing of user queries for enhanced information retrieval. The method includes generating self-complete derived queries from a search query. The method includes extracting query entities from each derived query and mapping the query entities with a plurality of electronic documents to identify a set of relevant electronic documents. The method includes sorting the derived queries based on the number of relevant electronic documents related to each derived query to obtain a sorted sequence of derived queries and searching a result for each derived query sequentially from the set of relevant electronic documents according to the sorted sequence of derived queries, and appending the result retrieved for one derived query with a consequent derived query to obtain a final search result. The method involves breakdown of a search query into derived queries and resolve each derived query separately and sequentially to reduce complexity and computation cost.

### FIELD OF TECHNOLOGY

The present disclosure generally relates to information retrieval and question-answering systems in the field of search technologies. Specifically, the present disclosure relates to a method and a system for multi-stage processing of user queries for enhanced information retrieval.

### BACKGROUND

In the areas of information retrieval and question-answering, there are several challenging problems that researchers and practitioners are actively working on. For example, one of the main challenges is to develop systems that can understand the meaning of queries and documents at a deeper semantic level. Traditional keyword-based approaches may fail to capture the context and nuances of natural language, leading to inaccurate retrieval and unsatisfactory question-answering results. In another example, ambiguity is another issue in information retrieval and question-answering related systems. Queries and documents can have multiple interpretations, and determining the intended meaning can be difficult. Further, in many applications, such as chatbots or virtual assistants, real-time or interactive retrieval and question-answering are essential.

The challenge lies in providing accurate and timely responses within tight time constraints, while still maintaining high quality. If the system fails to understand the query's intent or misinterprets its meaning, it may retrieve documents that do not address the user's information needs. Similarly, long and complex queries may contain unnecessary or confusing information, making it challenging for the system to identify the key aspects and retrieve relevant results. Moreover, long and complex queries often require more computational resources to process. The increased query length can impact the efficiency of indexing and retrieval operations, resulting in slower response times and higher computational costs. This can be especially problematic in real-time or interactive systems where quick response is crucial.

Further limitations and disadvantages of conventional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a method and a system for multi-stage processing of user queries for enhanced information retrieval. The present disclosure seeks to provide a solution to the existing problem of ambiguity and inefficient query processing leading to increased challenges for a system to identify the key aspects and retrieve relevant results. Moreover, long, and complex queries often require more computational resources to process, making them unsuitable or ineffective for real-time or interactive retrieval and question-answering. The challenge lies in providing accurate and timely responses within tight time constraints, while still maintaining high quality (highly relevant). An aim of the present disclosure is to provide a solution that overcomes at least partially the problems encountered in the prior art and provide an improved method and an improved system for multi-stage processing of user queries for enhanced information retrieval.

In one aspect, the present disclosure provides a method for multi-stage processing of user queries for enhanced information retrieval. The method comprises steps of generating, by a server, two or more derived queries from a user search query in a split stage. Moreover, each of the two or more derived queries have a length less than a first length of the user search query received originally from a client device. Furthermore, the two or more derived queries are independent and self-complete queries derived based on a user intent associated with the user search query. Further, the method comprises extracting, by the server, one or more query entities from each derived query of the two or more derived queries and mapping, by the server, the one or more query entities from each derived query with a plurality of electronic documents from a plurality of diverse data sources in a selection stage to concurrently identify a set of relevant electronic documents for each derived query. In addition, the method comprises sorting, by the server, the derived queries in a sorting stage based on a number of relevant electronic documents related to each derived query to obtain a sorted sequence of derived queries. Moreover, the sorted sequence of derived queries is indicative of an order in which each derived query is to be resolved. Further, the method comprises steps of searching, by the server, a result associated with each derived query in a search stage sequentially by analyzing the set of relevant electronic documents based on the sorted sequence of derived queries, and appending, by the server, the result retrieved for one derived query with a consequent derived query in the sorted sequence of derived queries in a supplementing stage to obtain a final search result for the user search query.

The method includes breaking down complex user queries in multiple stages to obtain simple or self-complete mini queries (i.e., two or more derived queries), and each derived query is resolved separately and sequentially, which not only reduces computational time and cost in resolving complex queries, but also improves relevance of the end results in a search. The method implements a Chain-of-Searches (CoS) technique through multi-stage processing, which solves the challenging problems in the areas of information retrieval and question-answering by breaking down user search into user intents and one or more self-complete derived queries (i.e., mini-queries), which when sorted and answered in a sequential manner, provide the required answer to the original search along with intermediate query-answer pairs as evidence leading to the final response. This is achieved through the 5S stages, i.e., the split stage, the selection stage, the sorting stage, the search stage, and the supplementing stage. In contrast to conventional methods, the method does not require an extensive evaluation of multiple candidate answers for each question/query, instead, the method of the present disclosure adopt a sequential manner of finding a unique extractive and generative answer for a first derived query (mini-query) and supplementing it to the next derived query (next mini-query) available in the sorted list of derived queries until all derived queries (mini-queries) are answered. In addition to providing the answer, the split stage also identifies the user intent, thereby allowing to rephrase the answer. In the supplementing stage, the appending or supplementing of successive derived queries with previous intermediate results by the system acts as a constraint for granular responses, which results in a focused and faster retrieval of the final result to the original user query.

In another aspect, the present disclosure provides a system for multi-stage processing of a user query for enhanced information retrieval, the system comprises a server configured to generate two or more derived queries from a user search query in a split stage. Moreover, each of the two or more derived queries have a length less than a first length of the user search query received originally from a client device. Furthermore, two or more derived queries are independent and self-complete queries derived based on a user intent associated with the user search query. Further, the server is configured to extract one or more query entities from each derived query from the two or more derived queries and map the one or more query entities from each derived query with a plurality of electronic documents to identify a set of relevant electronic documents for each derived query distinctly in a selection stage. In addition, the server is configured to sort the two or more derived queries based on a number of relevant electronic documents related to each derived query to obtain a sorted sequence of derived queries. The sorted sequence of derived queries is indicative of an order in which each derived query is to be resolved. Further, the server is configured to search a result associated with each derived query in a search stage sequentially by analyzing the set of relevant electronic documents based on the sorted sequence of derived queries, and append the result retrieved for one derived query with a consequent derived query in the sorted sequence of derived queries in a supplementing stage to obtain a final search result for the user search query.

The system achieves all the advantages and technical effects of the method of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not too scaled. Wherever possible, like elements have been indicated by identical numbers.

Embodiments of the present disclosure will now be described, by way of example only, with reference to the following diagrams wherein:

FIG. 1A is a network diagram of a system for multi-stage processing of user queries for enhanced information retrieval, in accordance with an embodiment of the present disclosure;

FIG. 1B is a diagram of a server with different components for multi-stage processing of user queries for enhanced information retrieval, in accordance with an embodiment of the present disclosure;

FIG. 2 is a diagram that depicts stages performed by the system for multi-stage processing of user queries for enhanced information retrieval, in accordance with an embodiment of the present disclosure;

FIG. 3 is a diagram illustrating a split stage in a multi-stage processing of user queries in accordance with an embodiment of the present disclosure;

FIG. 4 is a diagram illustrating a sorting stage of a multi-stage processing of user queries, in accordance with an embodiment of the present disclosure;

FIG. 5 is a diagram illustrating an exemplary scenario of a searching stage and supplementing stage of a multi-stage processing of user queries for enhanced information retrieval, in accordance with an embodiment of the present disclosure; and

FIG. 6 is a flowchart of a method for multi-stage processing of user queries for enhanced information retrieval, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

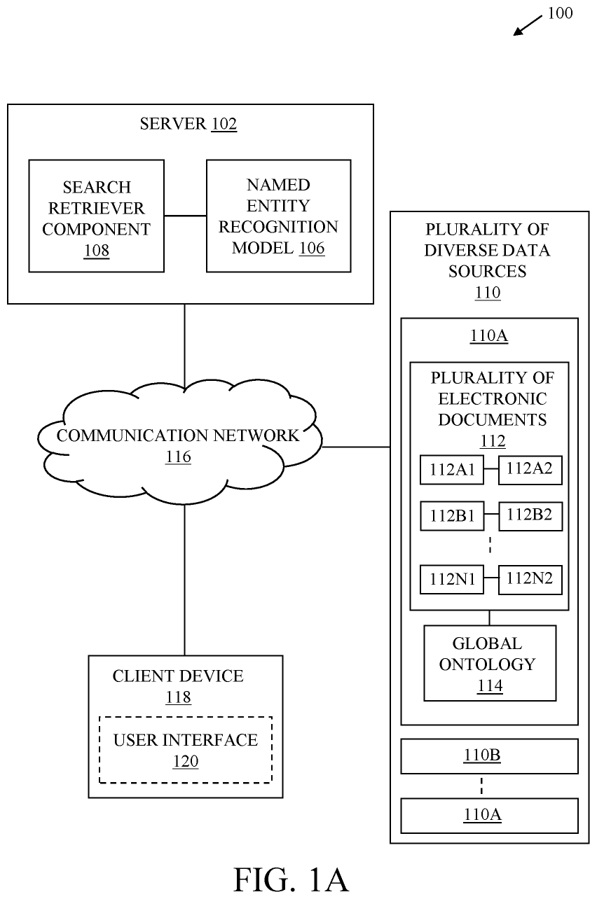

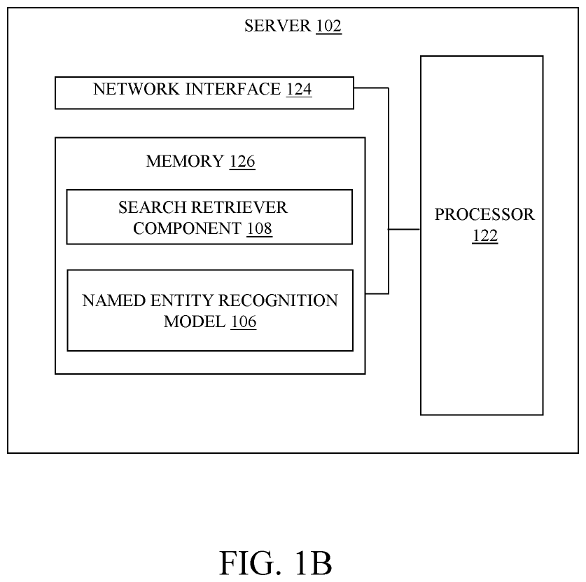

FIG. 1A is a network diagram of a system for multi-stage processing of user queries for enhanced information retrieval, in accordance with an embodiment of the present disclosure. With reference to FIG. 1A, there is shown a block diagram of a system 100. The system 100 includes a server 102. The server 102 includes a search retriever component 108 communicatively coupled to a named entity recognition (NER) model 106. Further, the system 100 includes a plurality of diverse data sources 110, such as a first data source 110A, a second data source 110B up to Nth data source 110N, communicatively coupled with the server 102 via a communication network 116. Moreover, the server 102 is communicatively coupled to a plurality of client devices, such as a client device 118, via the communication network 116. There is further shown a user interface 120 rendered on the client device 118. Each data source from the plurality of diverse data sources 110 may include a plurality of electronic documents 112 (shown in the first data source 110A for example), such as a first electronic document 112A1 along with a first metadata 112A2, a second electronic document 112B1 along with a second metadata 112B2 up to Nth electronic document 112N1 with Nth metadata 112N2. Further, the server 102 is configured to create a global ontology 114 from the data stored in the plurality of electronic documents 112.

The server 102 is configured to communicate with the client device 118 via the communication network 116. In an implementation, the server 102 may be a master server or a master machine that is a part of a data center that controls an array of other cloud servers communicatively coupled to it for load balancing, running customized applications, and efficient data management. Examples of the server 102 may include, but are not limited to a cloud server, an application server, a data server, or an electronic data processing device.

The search retriever component 108 may be configured to retrieve relevant data from the plurality of diverse data sources 110 in response to the user queries received through the client device 118. The search retriever component 108 may be a logic code, a hardware component (for example, implemented in the form of a circuitry), or a combination of hardware and software.

The NER model 106 is a type of natural language processing (NLP) model that is designed to identify and classify named entities in the user queries. The NER model 106 in the server 102 is trained by an external computational system to identify the named entities in the two or more derived queries and retrieve corresponding data from the plurality of electronic documents 112 based on the named entities. The named entities refer to specific words or phrases in the two or more derived queries that represent real-world entities with distinct names, such as people, diseases, ages, dates, products, and the like.

The plurality of diverse data sources 110 refers to multiple data sources related to one or more domains that are different in terms of their format, structure, and content. Examples of the plurality of diverse data sources 110 may include patient data, medical records, marketing data, financial data, and the like. In an implementation, the plurality of diverse data sources 110 refer to a cloud-based server having large amount of information stored related to multiple domains. Each data source from the plurality of diverse data sources 110 may include the plurality of electronic documents 112. In an implementation, the server 102 is configured to create the global ontology 114 based on the data present in the plurality of electronic documents 112 in each data source from the plurality of diverse data sources 110. The global ontology 114 refers to a formal representation of concepts and relationships in plurality of domains of knowledge that are shared across the plurality of diverse data sources 110. In another implementation, the plurality of diverse data sources 110 includes data related to different domains and data for each domain is stored in the form of global ontology 114. In an implementation, each electronic document of the plurality of electronic documents 112 are configured to store textual data related to one or more domains, such as medical, finance, marketing, retail stores and the like. Examples of the plurality of electronic documents 112 may include food and drug administration, FDA, documents, PubMed corpus, patients table and the like. The metadata of each electronic document from the plurality of electronic documents 112, such as the first metadata, the second metadata up to the third metadata, refers to a descriptive information or attributes that provide details about corresponding electronic document. Examples of the metadata may include title, author, date created, date modified, file format, size, version, and the like.

The communication network 116 includes a medium (e.g., a communication channel) through which the client device 118 communicates with the server 102. The communication network 116 may be a wired or wireless communication network. Examples of the communication network 116 may include, but are not limited to, Internet, a Local Area Network (LAN), a wireless personal area network (WPAN), a Wireless Local Area Network (WLAN), a wireless wide area network (WWAN), a cloud network, a Long-Term Evolution (LTE) network, a Metropolitan Area Network (MAN), and/or the Internet.

The client device 118 refers to an electronic computing device operated by a user. The client device 118 may be configured to obtain the user queries in a search portal or a search engine rendered over the user interface 120 and communicate the user queries to the server 102. The server 102 may then be configured to retrieve the group of similar data items. Examples of the client device 118 may include but are not limited to a mobile device, a smartphone, a desktop computer, a laptop computer, a Chromebook, a tablet computer, a robotic device, or other user devices.

It should be understood by one of the ordinary skills in the art that the operations of the system 100 are explained by using a single client device and a single user query. However, the operation of the system 100 is equally applicable for a number of user queries received from thousands to millions of client devices, where the user queries are processed in parallel.

In operation, the server 102 is configured to receive a user search query from the client device 118. A user may provide an input via the user interface 120 to submit the user search query. In an implementation, the user search query is in the form of a text input, whereas in another implementation, the user search query is in the form of text transcribed from a voice command entered by a user through the client device 118. The server 102 is configured to divide the user search query into two or more derived queries based on the user intent, which are self-complete in nature.

Furthermore, the server 102 is configured to identify relevant data source from the plurality of diverse data sources 110. Further, based on the global ontology 114, the server 102 is configured to identify a set of relevant electronic documents from the plurality of electronic documents 112 stored in relevant data source through the NER model 106. After identifying the set of relevant electronic documents for each derived query, the server 102 is configured to sort the two or more derived queries based on the number of relevant electronic documents to form a sorted sequence of derived queries. The sorted sequence of derived queries is formed by listing the derived queries based on the lowest to highest number of relevant electronic documents. After forming the sorted sequence of derived queries, the server 102 is configured to perform a chain of searches on each derived query to determine the result for the two or more derived queries in order listed in the sorted sequence. At the time of resolving each of the two or more derived queries, the server 102 is configured to supplement the result obtained for one derived query with next derived query in the sorted sequence of derived queries until a final search result for the original complex user query is obtained. The server 102 is configured to determine the final search result to the user query along with intermediate query-result pair for each of the derived queries to improve accuracy of the final search result. In other words, the system 100 is configured to break down complex user queries in multiple stages to obtain simple or self-complete mini queries (i.e., two or more derived queries), and each derived query is resolved separately and sequentially, which not only reduces computational time and cost in resolving complex queries, but also improves relevance of the end results in a search. The system 100 implements a Chain-of-Searches (CoS) technique through multi-stage processing, which solves the challenging problems in the areas of information retrieval and question-answering by breaking down user search into user intents and one or more self-complete derived queries (i.e., mini-queries), which, when sorted and answered in a sequential manner, provide the required answer to the original search along with intermediate query-answer pairs as evidence leading to the final response. This is achieved through the 5S stages, i.e., the split stage, the selection stage, the sorting stage, the search stage, and the supplementing stage. In contrast to conventional methods, the method does not require an extensive evaluation of multiple candidate answers for each question/query, instead, the system 100 of the present disclosure adopt a sequential manner of finding a unique extractive and generative answer for a first derived query (mini-query) and supplementing it to the next derived query (next mini-query) available in the sorted list of derived queries until all derived queries (mini-queries) are answered. In addition to providing the answer, the split stage in the system 100 also identifies the user intent, thereby allowing to rephrase the answer. In the supplementing stage, the appending or supplementing of successive derived queries with previous intermediate results by the system acts as a constraint for granular responses, which results in a focused and faster retrieval of the final result to the original user query.

FIG. 1B is a diagram of a server with different components for multi-stage processing of user queries for enhanced information retrieval, in accordance with an embodiment of the present disclosure. FIG. 1B is described in conjunction with the elements of FIG. 1A. With reference to FIG. 1B, there is shown the server 102, which includes a processor 122, a network interface 124 and a memory 126. Further, the memory 126 includes the search retriever component 108 and the NER model 106.

The processor 122 refers to a computational element that is operable to respond to and processes instructions that drive the system 100. The processor 122 may refer to one or more individual processors, processing devices, and various elements associated with a processing device that may be shared by other processing devices. Additionally, the one or more individual processors, processing devices, and elements are arranged in various architectures for responding to and processing the instructions that drive the system 100. In some implementations, the processor 122 may be an independent unit and may be located outside the server 102 of the system 100. Examples of the one or more processors 104 may include but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The memory 126 is configured to store the instructions executable by the processor 122. Examples of implementation of the memory 126 may include, but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

The network interface 124 refers to a communication interface to enable communication of the server 102 to any other external device, such as the client device 118 (of FIG. 1A). Examples of the network interface 124 include, but are not limited to, a network interface card, a transceiver, and the like.

In operation, the processor 122 is configured to receive a user search query through the client device 118 via the network interface 124. The processor 122 is configured to divide the user search query into two or more derived queries based on the user intent, which are self-complete in nature. Furthermore, the processor 122 is configured to identify relevant data source from the plurality of diverse data sources 110 (of FIG. 1). Further, based on the global ontology 114, the processor 122 is configured to identify a set of relevant electronic documents from the plurality of electronic documents 112 stored in relevant data source through the NER model 106. After identifying the set of relevant electronic documents for each derived query, the processor 122 is configured to sort the two or more derived queries based on the number of relevant electronic documents to form the sorted sequence of derived queries. After forming the sorted sequence of derived queries, the processor 122 is configured to perform a chain of searches on each derived query to determine the result for the two or more derived queries in order listed in the sorted sequence. At the time of resolving each of the two or more derived queries, the processor 122 is configured to supplement the result obtained for one derived query with next derived query in the sorted sequence of derived queries until a final search result for the original complex user query is obtained. The processor 122 is configured to determine the final search result to the user query along with intermediate query-result pair for each of the derived queries to improve accuracy of the final search result.

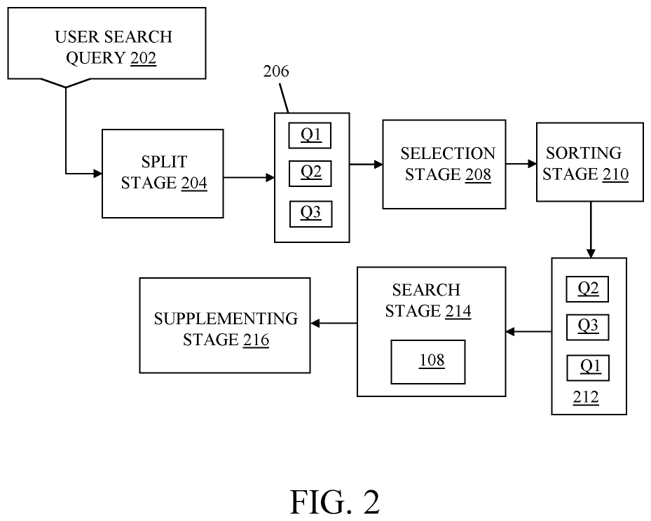

FIG. 2 is a block diagram that depicts stages performed by the system for multi-stage processing of user queries for enhanced information retrieval, in accordance with an embodiment of the present disclosure. FIG. 2 is described in conjunction with elements of FIGS. 1A and 1B. With reference to FIG. 2, there are shown multiple stages in which a user search query 202 is processed to obtain a final result, such as a split stage 204, a selection stage 208, a sorting stage 210, a search stage 214, and a supplementing stage 216.

In operation, the server 102 of the system 100 is configured to receive a user search query 202 from a user through the client device 118. In operation, the server 102 is configured to generate the two or more derived queries 206 from the user search query 202 in the split stage 204. The two or more derived queries 206 are self-complete mini queries, which derive origin from the user search query 202. Here, the self-complete mini queries infers that each derived query from the two or more derived queries 206 is a standalone or has separate meaning. Moreover, each of the two or more derived queries 206 have a length less than a first length of the user search query received originally from the client device 118. In an implementation, the first length of the user search query 202 refers to the number of words present in the user search query 202. For example, the user search query 202 may be “Where did Canadian citizens with the Turing award graduate?” (9 words). The server 102 generates two derived queries from the user search query 202 as “Canadian citizens that won the Turing award” (7 words) and “‘Where did Canadian citizens graduate?” (5 words). In such example, each derived query is having lesser number of words as compared to the user search query 202. In addition, the two or more derived queries 206 are independent and self-complete queries derived based on a user intent associated with the user search query 202. The user intent refers to an underlying purpose or goal that a user has when providing the user search query 202 to the server 102. Examples of the user intent may include informational intent, commercial intent, and the like. In an example, the user requires information regarding medical dosage to be given to a patient listed in a hospital database. In such example, the user's intent is both informational and commercial. With reference to FIG. 2, the server 102 is configured to generate three derived queries, for example, as Q1, Q2 and Q3. In accordance with an embodiment, two or more derived queries 206 encompasses one or more common words or connecting words that connects the two or more derived queries to the user search query 202. For example, the user search query 202 may be “Who is the lead singer of the band that won the Japan Record Special Award in 2016?”. Here, the server 102 generates two derived queries as “Band that won the Japan Record Special Award in 2016” and “‘Who is lead singer of the band?”. Here, “band” is common word or connecting word in both derived queries. The common word or connecting word establishes relation between the two derived queries, which enables the server 102 to combine the information retrieved for each derived query to obtain the final search result.

The server 102 is further configured to extract one or more query entities from each derived query from the two or more derived queries 206. The one or more query entities refer to key words, numbers, or phrases, which are indicative of type of information depicted within the two or more derived queries 206. For example, the user search query 202 may be “Who is the lead singer of the band that won the Japan Record Special Award in 2016?”. Here, the server 102 generates two derived queries as “Band that won the Japan Record Special Award in 2016” and “‘Who is lead singer of the band?”. Here, the key words “band”, “lead singer”, “Japan Record Special Award” and “2016” are query entities. The query entity “band” indicates the musical ensemble or group of musicians, “lead singer” indicates type of musician, “Japan Record Special Award” indicates the type of award and “2016” indicates the date. Due to extraction of the above query entities, the server 102 is enabled to search for relevant data source having information about musicians, bands, and awards.

The server 102 is further configured to map the one or more query entities from each derived query with the plurality of electronic documents 112 to identify the set of relevant electronic documents for each derived query distinctly in a selection stage 208. The set of relevant electronic documents has data related to the type of information indicated through the one or more query entities. For example, the user search query 202 may be having query entities as “John Davis”, “50 years old” and “male”, which indicates types of information as “person name”, “age”, and “gender”. Further, based on the query entities, the server 102 is configured to identify the set of relevant electronic documents having information about person names, ages, and genders.

In accordance with an embodiment, the mapping of the one or more query entities from each derived query is performed by creating the global ontology 114 based on information present in the plurality of electronic documents 112 and corresponding metadata. In an implementation, the global ontology 114 includes data in the form of tables, classes, data properties, object properties and the like from all the plurality of electronic documents 112 in a single data source from the plurality of diverse data sources 110. For example, a data source is related to patient database in a hospital. Here, the global ontology 114 includes following tables as

TABLE 1
Patients Table

patient_id (primary key)
first_name
last_name
date_of_birth
Gender
Address
phone_number
Email

TABLE 2
Medicine Table

medicine_id (primary key)
medicine_name
Manufacturer
Dosage
expiry_date
Price
Description

TABLE 3
Data Properties:

patient_id (source table: Patient Table)
first_name (source table: Patient Table)
last_name (source table: Patient Table)
date_of_birth (source table: Patient Table)
gender (source table: Patient Table)
medicine_id (source table: Medicine Table)
medicine_name (source table: Medicine Table)
prescribed_date (source table:
Patient_Medicine Table)
dosage_instructions (source table:
Patient_Medicine Table)
duration_of_treatment (source table:
Patient_Medicine Table)

TABLE 4
Object Properties:

hasPrescription (source tables: Patient Table,
Medicine Table, Patient_Medicine Table)
hasPatient (source table: Patient_Medicine
Table)

The global ontology 114 provides a systematic arrangement of data in the plurality of electronic documents 112, which reduces time for searching of data in the data source for resolving the user search query 202.

After creating the global ontology 114, the server 102 is configured to tag the one or more query entities in each derived query with corresponding relevant sections of information from the global ontology 114. In the context of the global ontology 114, the relevant sections of information refer to the tables or classes in the global ontology 114, which are related to the one or more query entities in the two or more derived queries 206. For example, the user search query 202 may be “What should be the dosage of Paracetamol for the patient: John Davies, 50 years old, male?” and the derived queries are “John Davies, 50 years old, male” and “What should be the dosage of Paracetamol for the patient”. Here, the query entities are “patient”, “Paracetamol”, “John Davies”, “50 years old”, and “male”. The query entities “patient”, “John Davies”, “50 years old” and “male” are related to the patients table (i.e., table 1) and the query entity “Paracetamol” is related to the medicine table (i.e., table 2). Further, the query entity “John Davies” is mapped with the class “patient” from the class table (i.e., table 3), and data properties “first_name” and “last name” from the data properties table (i.e., table 3). Further, the query entity “50 years old” is mapped with the data property “date_of_birth”, and “male” is mapped with the data property “gender” from the data property table and “Paracetamol” is mapped with the data property “medicine_name” from the data property table. The data properties “first_name”, “last_name”, “date of birth” and “gender” are included in the patient table (i.e., patient table, that is the table 1 is source of the data properties “first_name”, “last_name”, “date of birth” and “gender”), whereas the data property “medicine name” is included in the medicine table (i.e., medicine table (table 2) is source of the data property “medicine_name”). In other words, the data property table acts as a connecting link between the one or more query entities and source tables, such as the patient table and the medicine table. In such example, the derived query “John Davies, 50 years old, male” requires data from the patients table, the class table, and the data property table, whereas the derived query “What should be the dosage of Paracetamol for the patient” requires data from the patients table, the class table, the data property table along with the medicine table.

In accordance with an embodiment, the tagging of the one or more query entities in each derived query with corresponding relevant sections of information from the global ontology 114 is performed based on the NER model 106. The NER model 106 is trained to enable the server 102 to identify the relevant sections of information from the global ontology 114 based on named entities. In continuation with the previous example, the named entities in the one or more query entities are “John Davies” (representing the name of person), “Paracetamol” (representing the name of medicine), “50 years old” (representing the age), “male” (representing the gender). Based on such named entities, the server 102 is configured to tag the corresponding tables in the global ontology 114 as “relevant” to a particular query entity. In accordance with another embodiment, the relevant sections of information from the global ontology 114 are determined based on a similarity between keywords or key phrases in the one or more query entities in each derived query and the global ontology 114. The key words or key phrases in the one or more query entities in the previous example are “John Davies”, “Paracetamol”, “patient”, “50 years old”, and “male”. The server 102 is configured to find matching keywords with that of the data in the global ontology 114 to identify relevant sections of information, that is, tables such as patient table and medicine table.

In accordance with an embodiment, in the selection stage 208, during the mapping of the one or more query entities from each derived query, each of the two or more derived queries 206 is mapped to a relevant data source of the plurality of diverse data sources 110 based on a type of the one or more query entities in each derived query. As the plurality of diverse data sources 110 includes data related to multiple domains, the server 102 is configured to select relevant data source related to the domain in which the user search query 202 belongs to. For example, the plurality of diverse data sources 110 includes data sources such as medical records, financial data, marketing data and the like. In such example, the user query is “What are the names of patients between age 20-25 years old having cholera”. In such user query, the one or more query entities are “patient”, “age”, “cholera”, which are related to medical domain. Based on the one or more query entities, the server 102 is configured to select the data source related to medical domain from the plurality of diverse data sources 110.

Further, the server 102 is configured to identify the set of relevant electronic documents from the plurality of electronic documents 112 for each query entity based on the relevant sections of information. In continuation with previous example, for the derived query “John Davies, 50 years old, male”, the server 102 is configured to traverse through the plurality of electronic documents 112 that include the patient table, whereas for the for the derived query “What should be the dosage of Paracetamol for the patient?”, the server 102 is configured to traverse through the plurality of electronic documents 112 that include the patient table and the medicine table. Further, the server 102 is configured to identify the set of relevant electronic documents that include the patient tables and medicine tables, and classify the set of relevant electronic documents for each derived query.

After identifying the set of relevant documents for each derived query, the server 102 is configured to sort the two or more derived queries based on a number of relevant electronic documents related to each derived query to obtain the sorted sequence of derived queries 212. Moreover, the sorted sequence of derived queries 212 is indicative of an order in which each derived query is to be resolved. With reference to FIG. 2, the server 102 is configured to identify the set of relevant electronic documents for derived queries Q1, Q2 and Q3. For example, the derived query Q1 is having 50 relevant electronic documents, Q2 is having 30 relevant electronic documents and Q3 is having 20 relevant electronic documents out of total 100 electronic documents. In accordance with an embodiment, the order in which each derived query is to be resolved is determined based on a lowest to highest number of relevant electronic documents retrieved for each derived query. Moreover, the derived query associated with the lowest number of relevant electronic documents is resolved initially followed by other derived queries. With reference to FIG. 2, the derived query Q3 is having lowest number of relevant electronic documents (i.e., 20 relevant electronic documents), subsequently followed by the derived query Q2 (30 relevant electronic documents) and at last, the derived query Q1 is having the highest number of relevant electronic documents (i.e., 50 relevant electronic documents). Therefore, the server 102 is configured to create the sorted sequence of derived queries 212 as Q3, followed by Q2, followed by Q1, as shown in FIG. 2. In other words, the derived query Q3 is resolved first, followed Q2 and the derived query Q1 is resolved at the end.

After determining the sorted sequence of derived queries 212, the server 102 is configured to search a result associated with each derived query in a search stage 214 sequentially by analyzing the set of relevant electronic documents based on the sorted sequence of derived queries 212. The search stage 214 is carried out by the search retriever component 108. With reference to FIG. 2, the derived query Q3 is having lowest number of relevant electronic documents. Therefore, the server 102 is configured to search through the set of relevant electronic documents for the derived query Q3 to determine corresponding result. Further, the server 102 is configured to append the result retrieved for one derived query with a consequent derived query in the sorted sequence of derived queries 212 in a supplementing stage 216 to obtain a final search result for the user search query 202. The search stage 214 and the supplementing stage 216 are explained with the help of following example:

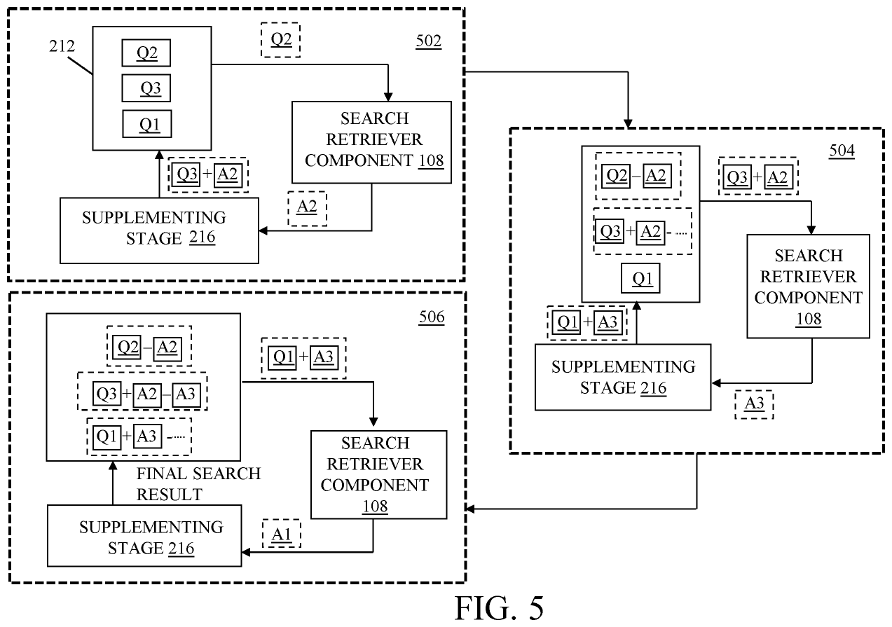

Let's consider the user search query “What is the projected market for the use case which uses the service that is also used by a US state for emergency call centers' backup?”. The server 102 is configured to generate three derived queries Q1, Q2 and Q3 as:
1) ‘What is projected market for the use case ?(Q1)
2) ‘Use case which uses the service (Q2)
3) ‘The service that is also used by a US state for emergency call centers backup (Q3)
   Further, the server 102 is configured to sort the derived queries Q1, Q2 and Q3 to obtain the sorted sequence of derived queries 212 as Q3-Q2-Q1. Further, the result for the derived query Q3 is obtained as “FirstNet” from the set of relevant electronic documents. Further, the result “FirstNet” is appended with the derived query Q2 to form a modified derived query Q2 as: “use case which uses the service FirstNet”. Further, the result for the modified derived query Q2 is further searched through the set of relevant documents. In such case, the result for the modified derived query Q2 is “Robotic Dogs”. Further, the result obtained for the modified derived query Q2 is further appended with the derived query Q1 to obtain a modified derived query Q3 as: ‘What is projected market for the Robotic Dogs use case?”. Further, the server 102 is configured to determine the search result of the modified derived query Q3 from the corresponding set of relevant electronic documents to obtain the final search result of the user search query 202 as “$13.4 billion”. The final search result for the user search query 202 “What is the projected market for the use case which uses the service that is also used by a US state for emergency call centers' backup?” is “$13.4 billion”. The server 102 is configured to obtain the final search result by determining intermediate search results for each derived query and supplement the search results sequentially to obtain the final result. The details of search stage and supplement stage are further mentioned in FIG. 5.

In accordance with an embodiment, in the search stage 214, the searching is independent of a requirement of data to follow an explicit fixed schema. The explicit fixed schema refers to a predefined and rigid structure that governs the organization and representation of data within the plurality of diverse data sources 110. The server 102 is designed to handle data with varying structures, allowing for a more dynamic and adaptable approach towards data retrieval. In a scenario, the data stored in the plurality of electronic documents 112 within the plurality of diverse data sources 110 may vary in their structures. For instance, some electronic documents store data in the form of headings, paragraphs, bullet points, tables, or other formatting elements. The server 102 is configured to handle the variations in content structure and retrieve relevant information regardless of the specific organization, as the data is retrieved with the help of semantic search.

In accordance with an embodiment, the searching of the result associated with each derived query in the search stage 214 is performed by generating a combination of database search queries for each derived query and further performing a semantic search for structured and unstructured electronic documents for each derived query. In an implementation, the combination of database search queries is in the form of a structured query language (SQL). For example, the user search query 202 may be “What should be the dosage of Paracetamol for the patient: John Davies, 50 years old, male?” and the server 102 generates two derived queries as “John Davies, 50 years old, male” and “What should be the dosage of Paracetamol for the patient?”. In such example, the server 102 is configured to extract the one or more query entities as “Patient”, “Paracetamol”, “John Davies”, “50 years old”, “dosage”, “male”. Further, the server 102 is configured to generate the combination of search queries as:

SELECT pm.dosage_instructions
FROM Patient p
JOIN Patient_Medicine pm ON p.patient_id = pm.patient_id
JOIN Medicine m ON pm.medicine_id = m.medicine_id
WHERE p.first_name = ‘John’ AND p.last_name =
‘Davies’ AND p.gender = ‘male’
AND p.date_of_birth <= DATEADD(year, −50, GETDATE( ))
AND m.medicine_name = ‘Paracetamol’

The combination of database search queries joins the patient tables and medicine tables using their respective foreign keys, and then applies filters for the patient's name, age, gender, and the medicine name to retrieve the dosage instructions for the Paracetamol. The semantic search involves understanding the underlying structure and relationships between the one or more query entities in the user search query. The operation of server 102 during the semantic search is explained as follows: In continuation with the previous example, the derived queries are “John Davies, 50 years old, male” and “What should be the dosage of Paracetamol for the patient”. During the semantic search of the former derived query, the server 102 understands the context of the derived query and recognize the named entities: “John Davies” as the patient's name, “50 years old” as the patient's age, and “male” as the patient's gender. The server 102 utilizes this information to retrieve the set of relevant electronic documents about the patient from structured or unstructured documents, such as medical records or patient profiles. During the semantic search of the latter derived query, the server 102 considers the user intent of the derived query and recognizes the one or more entities as “dosage,” “Paracetamol,” and “patient.” Further, the server 102 is configured to comprehend the relationship between the query entities and corresponding context. Further, the server 102 is configured to retrieve set of relevant documents having information about Paracetamol dosages specifically tailored for patients, taking into account factors like age, gender, and any other relevant medical conditions. By combining the results of both derived queries, the semantic search provides a more accurate and contextually relevant response to the user search query 202.

In an implementation, the server 102 is configured to utilize a large language model (LLM) for retrieving the final search result for the user search query 202. The LLM refers to a machine learning model based on deep learning techniques, such as deep neural networks, and is trained on vast amounts of textual data to develop a comprehensive understanding of language patterns and structures. By implementing the LLM, the server 102 is configured to receive the user search query 202 through an application programming interface (API) or by directly interfacing with the LLM. The implementation of the LLM in the server enables the server to capture intricate nuances and context in human language in the user search query 202 and generate coherent and contextually relevant responses. In such case, the plurality of diverse data sources 110 includes a large number of electronic documents, typically in billions and the server 102 is configured to resolve the user search query based on the plurality of diverse data sources 110. An example of the operation of the server 102 in the LLM is explained as follows: The user search query 202 may be “Tweet about the dangers of taking a drug that is being used to treat a particular disease in patient Snow. Additionally, list the alternatives for this drug.”. Initially the server 102 is configured to generate three derived queries as based on

### Derived Queries:

1. The drug that is being used to treat a particular disease in patient Snow.
2. What are the dangers of taking this drug?
3. List the alternatives for this drug
   Further, the server 102 is configured to select relevant electronic documents from following data Sources (in the selection stage 208):
1. Patients table
2. PubMed corpus
3. FDA documents
   First, there is a requirement for information regarding what drug is being used to treat the particular disease in patient Snow. After getting the answer, there is requirement for information regarding the dangers of taking the drug. Finally, there is requirement to list the alternatives for this drug after knowing what the drug is and the dangers associated with the drug. Based on the above reasoning, the server 102 is configured to sort the derived queries to form the sorted sequence of derived queries 212 as follows:
1. the drug that is being used to treat a particular disease in patient Snow.
2. What are the dangers of taking this drug?
3. List the alternatives for this drug.
   Further, the server 102 is configured to resolve the derived queries sequentially to obtain the final result of the user search query 202.

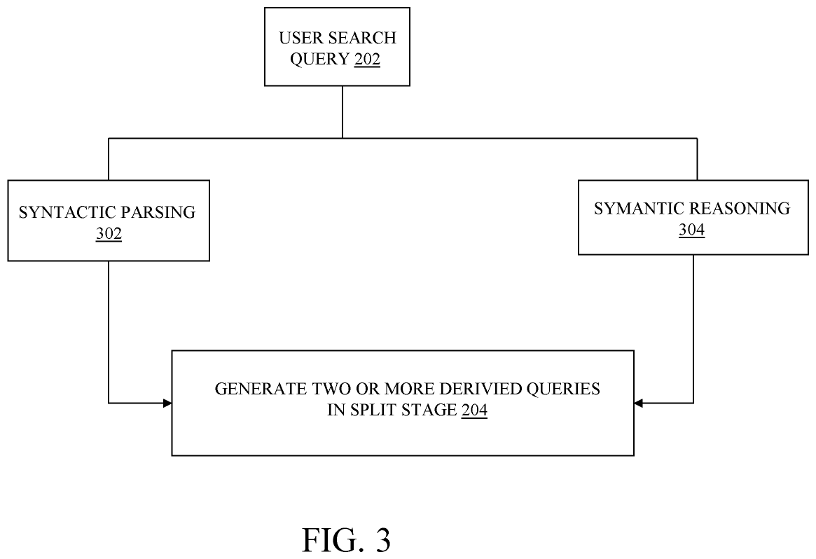

FIG. 3 is a block diagram of a split stage performed by the system for multi-stage processing of user queries for enhanced information retrieval, in accordance with an embodiment of the present disclosure. FIG. 3 is described in conjunction with the elements of FIGS. 3, there is shown the user search query 202 going through the split stage 204 in multiple ways. In accordance with an embodiment, in the split stage 204, the two or more derived queries 206 are derived by syntactic parsing 302 and semantic reasoning 304 based on a self-learned weighted combination operation. The syntactic parsing 302 refers to a process of analyzing the grammatical structure of a sentence. In the case of the user search query 202, the syntactic parsing involves breaking the user search query 202 into its constituent parts, such as nouns, verbs, adjectives, and other grammatical components. The semantic reasoning 304 includes understanding the meaning and intent behind the user search query 202. The semantic reasoning 304 aims to capture the user's intent and the underlying concepts. The self-learned weighted combination operation involves assigning weights or scores to each derived query based on certain criteria or factors. Such weights determine the relevance or importance of each derived query in relation to the user search query. For example, the user search query 202 may be “What should be the dosage of Paracetamol for the patient: John Davies, 50 years old, male?”. The user search query 202 focuses on the patient's specific details, such as the name (John Davies), age (50 years old), and gender (male), the medication (Paracetamol) and the patient's dosage requirement. Further, the server 102 assigns a weight of 0.6 to the information related to name, age, and gender of patient, whereas assigns a weight of 0.8 to the information related to the dosage of Paracetamol. The higher weight indicates higher relevance or importance assigned to the derived query and focus of the user. By considering such weights, the server 102 is configured to generate the derived queries that align with the user's intent.

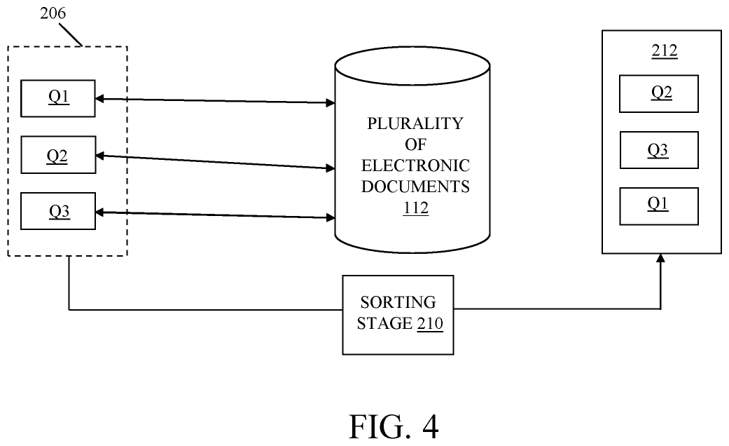

FIG. 4 is a block diagram of a sorting stage performed by the system for multi-stage processing of user queries for enhanced information retrieval, in accordance with an embodiment of the present disclosure. With reference to FIG. 4, there is shown the two or more derived queries 206, such as a first derived query Q1, a second derived query Q2 and a third derived query Q3 generated from the user search query 202 (of FIG. 2). Further, the server 102 (of FIG. 1) is configured to map the derived queries Q1, Q2 and Q3 with the plurality of electronic documents 112 to identify the set of relevant electronic documents. After identifying the set of relevant electronic documents for each derived query, the server 102 is configured to sort the derived queries Q1, Q2 and Q3 in increasing order of number of relevant documents in the sorting stage 210. The first derived query Q1 requires searching of 100 electronic documents, the second derived query Q2 requires searching of 20 electronic documents and the third derived query Q3 requires searching of 50 electronic documents. During the sorting stage 210, the server 102 is configured to determine the sorted sequence of derived queries 212 as Q2-Q3-Q1 (20 documents-50 documents-100 documents). Further, the server 102 is configured to resolve the derived queries Q1, Q2 and Q3 based on the order in the sorted sequence of derived queries 212.

FIG. 5 is a block diagram that depicts exemplary scenario of searching stage and supplementing stage performed by the system for multi-stage processing of user queries for enhanced information retrieval, in accordance with an embodiment of the present disclosure. With reference to FIG. 5, there are shown three operations, such as a first operation 502, a second operation 504 and a third operation 506 performed for resolving three derived queries generated by the server 102 (of FIG. 1) from the user search query 202 (of FIG. 2), the first derived query Q1, the second derived query Q2 and the third derived query Q3. Each of the operations 502, 504 and 506 involves the search stage 214 and the supplementing stage 216. In an implementation, the number of operations depends on the number of derived queries. The sequence of operations 502, 504 and 506 is illustrated by arrows in the FIG. 5. The sorted sequence of derived queries 212 includes the queries in order as Q2, Q3 and Q1.

In the first operation 502, the result for the second derived query Q2 is retrieved by the search retriever component 108 as a second result A2. Further, in the supplementing stage 216, the second result A2 is combined with the third derived query Q3 to obtain a modified third derived query, which is denoted as Q3+A2 in FIG. 5. Due to retrieval of the second result, the second derived query Q2 is converted to a modified second derived query Q2-A2. In the second operation 504, the server 102 is configured to resolve the modified third derived query Q3+A2 through the search retriever component 108 to obtain a third result A3. Further, in the supplementing stage 216, the third result A3 is combined with the first derived query Q1 to obtain a modified first derived query Q1+A3 in FIG. 5. Due to retrieval of the third result, the third result A3 is removed from the modified third derived query Q3+A2, which is denoted as Q3+A2-A3. Further, in the third operation 506, the server 102 is configured to retrieve a first result A1 for the modified first derived query Q1+A3 through the search retriever component 108. After obtaining the first result A1, the server 102 is configured to obtain the final search result through the supplementing stage 216. Therefore, the multiple operations similar to the sequence of operations 502, 504 and 506 are performed based on the number of derived queries for each user search query 202.

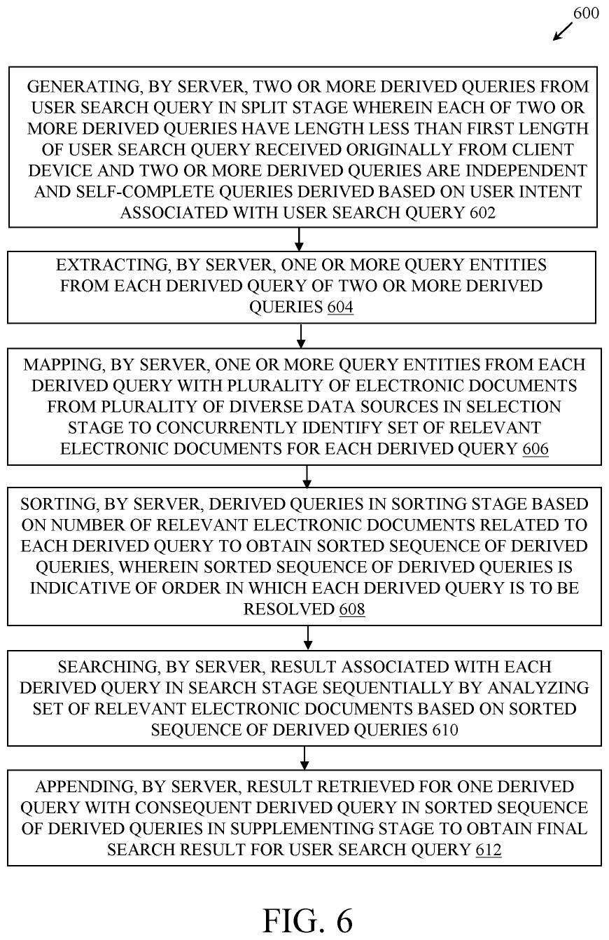

FIG. 6 is a flowchart of a method for multi-stage processing of user queries for enhanced information retrieval, in accordance with an embodiment of the present disclosure. FIG. 6 is described in conjunction with the elements of FIG. 1A to 5. With reference to FIG. 6, there is shown a method 600 for multi-stage processing of user queries for enhanced information retrieval. The method 600 includes steps from 602 to 612.

At step 602, the method 600 includes generating, by a server 102, two or more derived queries 206 (of FIG. 2) from a user search query 202 (of FIG. 2) in a split stage 204. Moreover, each of the two or more derived queries 206 have a length less than a first length of the user search query 202 received originally from a client device 118 (of FIG. 1), Furthermore, two or more derived queries 206 are independent and self-complete queries derived based on a user intent associated with the user search query 202. The user queries refer to specific requests or inputs made by the user to the system 100 in order to retrieve desired information from a database. The user intent refers to an underlying purpose or goal that a user has when providing the user search query 202 to the server 102. In accordance with an embodiment, the two or more derived queries 206 encompasses one or more common words or connecting words that connect the two or more derived queries to the user query. The common word or connecting word establishes relation between the two derived queries, which enables the server 102 to combine the information retrieved for each derived query to obtain the final search result of the original user search query. In accordance with an embodiment, in the split stage 204, the two or more derived queries are derived by syntactic parsing 302 and semantic reasoning 304 based on a self-learned weighted combination operation. The syntactic parsing 302 refers to a process of analyzing the grammatical structure of a sentence and the semantic reasoning 304 includes understanding the meaning and intent behind the user search query 202.

At step 604, the method 600 includes extracting, by the server 102, one or more query entities from each derived query of the two or more derived queries 206. The one or more query entities refer to key words, numbers, or phrases, which are indicative of type of information depicted within the two or more derived queries 206. For example, the user search query 202 may be “Who is the lead singer of the band that won the Japan Record Special Award in 2016?”. Here, the server 102 generates two derived queries as “Band that won the Japan Record Special Award in 2016” and “‘Who is lead singer of the band?”. Here, the key words “band”, “lead singer”, “Japan Record Special Award” and “2016” are query entities.

At step 606, the method 600 includes mapping, by the server 102, the one or more query entities from each derived query with a plurality of electronic documents 112 from a plurality of diverse data sources 110 in a selection stage 208 to concurrently identify a set of relevant electronic documents for each derived query. The set of relevant electronic documents has data related to the type of information indicated through the one or more query entities. For example, if the user search query 202 may be having query entities as “John Davis”, “50 years old” and “male”, which indicates types of information as “person name”, “age”, and “gender”. Further, based on the query entities, the server 102 is configured to identify the set of relevant electronic documents having information about person names, ages, and genders. In accordance with an embodiment, the mapping of the one or more query entities from each derived query is performed by creating a global ontology 114 based on information present in the plurality of electronic documents 112 and corresponding metadata. Furthermore, the mapping includes tagging the one or more query entities in each derived query with corresponding relevant sections of information from the global ontology 114. In addition, the mapping includes identifying the set of relevant electronic documents from the plurality of electronic documents 112 for each entity based on the relevant sections of information. In an implementation, the global ontology includes data in the form of tables, classes, data properties, object properties and the like from all the plurality of electronic documents 112 in a single data source from the plurality of diverse data sources 110. In accordance with an embodiment, tagging of the one or more query entities in each derived query with corresponding relevant sections of information from the global ontology 114 is performed based on the NER model 106. The NER model 106 is trained to enable the server 102 to identify the relevant sections of information from the global ontology based on named entities. In accordance with another embodiment, the relevant sections of information from the global ontology 114 are determined based on a similarity between keywords or key phrases in the one or more query entities in each derived query and the global ontology 114. In accordance with an embodiment, in the selection stage 208, during the mapping of the one or more query entities from each derived query, each of the two or more derived queries is mapped to a relevant data source of the plurality of diverse data sources 110 based on a type of the one or more query entities in each derived query.

At step 608, the method 600 includes sorting, by the server 102, the derived queries in a sorting stage 210 based on a number of relevant electronic documents related to each derived query to obtain a sorted sequence of derived queries 212, wherein the sorted sequence of derived queries 212 is indicative of an order in which each derived query is to be resolved. In accordance with an embodiment, the order in which each derived query is to be resolved is determined based on a lowest to highest number of relevant electronic documents retrieved for each derived query, wherein the derived query associated with the lowest number of relevant electronic documents is resolved initially followed by other derived queries

At step 610, the method 600 includes searching, by the server, a result associated with each derived query in a search stage 214 sequentially by analyzing the set of relevant electronic documents based on the sorted sequence of derived queries. The results for each derived query are retrieved by the search retriever component 108 (of FIG. 1). In accordance with an embodiment, the searching of the result associated with each derived query in the search stage 214 is performed by generating a combination of database search queries for each derived query and further performing a semantic search for structured and unstructured electronic documents for each derived query. In accordance with an embodiment, in the search stage 214, the searching is independent of a requirement of data to follow an explicit fixed schema.

At step 612, the method 600 includes appending, by the server 102, the result retrieved for one derived query with a consequent derived query in the sorted sequence of derived queries 212 in a supplementing stage 216 to obtain a final search result for the user search query 202.

The method 600 includes breaking down complex user queries in multiple stages to obtain simple or self-complete mini queries (i.e., two or more derived queries), and each derived query is resolved separately and sequentially, which not only reduces computational time and cost in resolving complex queries, but also improves relevance of the end results in a search. The method 600 includes implementing a Chain-of-Searches (CoS) technique through multi-stage processing, which solves the challenging problems in the areas of information retrieval and question-answering by breaking down user search into user intents and two or more self-complete derived queries (i.e., mini-queries), which, when sorted and answered in a sequential manner, provide the required answer to the original search along with intermediate query-answer pairs as evidence leading to the final response. This is achieved through the 5S stages, i.e., the split stage, the selection stage, the sorting stage, the search stage, and the supplementing stage. In contrast to conventional methods, the method 600 does not require an extensive evaluation of multiple candidate answers for each question/query, instead, the method 600 of the present disclosure adopt a sequential manner of finding a unique extractive and generative answer for a first derived query (mini-query) and supplementing it to the next derived query (next mini-query) available in the sorted sequence of derived queries until all derived queries (mini-queries) are answered. In addition to providing the answer, the split stage 204 also identifies the user intent, thereby allowing to rephrase the answer. In the supplementing stage 216 of the method 600, the appending or supplementing of successive derived queries with previous intermediate results acts as a constraint for granular responses, which results in a focused and faster retrieval of the final result to the original user query.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A method for multi-stage processing of user queries for enhanced information retrieval, the method comprising:
generating, by a server, two or more derived queries from a user search query in a split stage,
wherein each of the two or more derived queries have a length less than a first length of the user search query received originally from a client device,
and wherein two or more derived queries are independent and self-complete queries derived based on a user intent associated with the user search query;
extracting, by the server, one or more query entities from each derived query of the two or more derived queries;
mapping, by the server, the one or more query entities from each derived query with a plurality of electronic documents from a plurality of diverse data sources in a selection stage to concurrently identify a set of relevant electronic documents for each derived query;
sorting, by the server, the derived queries in a sorting stage based on a number of relevant electronic documents related to each derived query to obtain a sorted sequence of derived queries, wherein the sorted sequence of derived queries is indicative of an order in which each derived query is to be resolved;
searching, by the server, a result associated with each derived query in a search stage sequentially by analyzing the set of relevant electronic documents based on the sorted sequence of derived queries, and
appending, by the server, the result retrieved for one derived query with a consequent derived query in the sorted sequence of derived queries in a supplementing stage to obtain a final search result for the user search query.

2. The method according to claim 1, wherein in the split stage, the two or more derived queries are derived by syntactic parsing and semantic reasoning based on a self-learned weighted combination operation.

3. The method according to claim 1, wherein the two or more derived queries encompasses one or more common words or connecting words that connects the two or more derived queries to the user query.

4. The method according to claim 1, wherein the mapping of the one or more query entities from each derived query is performed by:
creating a global ontology based on information present in the plurality of electronic documents and corresponding metadata;
tagging the one or more query entities in each derived query with corresponding relevant sections of information from the global ontology; and
identifying the set of relevant electronic documents from the plurality of electronic documents for each entity based on the relevant sections of information.

5. The method according to claim 4, wherein the tagging of the one or more query entities in each derived query with corresponding relevant sections of information from the global ontology is performed based on a named entity recognition (NER) model.

6. The method according to claim 5, wherein the relevant sections of information from the global ontology are determined based on a similarity between keywords or key phrases in the one or more entities in each derived query and the global ontology.

7. The method according to claim 1, wherein the order in which each derived query is to be resolved is determined based on a lowest to highest number of relevant electronic documents retrieved for each derived query, wherein the derived query associated with the lowest number of relevant electronic documents is resolved initially followed by other derived queries.

8. The method according to claim 1, wherein the searching of the result associated with each derived query in the search stage is performed by generating a combination of database search queries for each derived query and further performing a semantic search for structured and unstructured electronic documents for each derived query.

9. The method according to claim 1, wherein in the search stage, the searching is independent of a requirement of data to follow an explicit fixed schema.

10. The method according to claim 1, wherein in the selection stage, during the mapping of the one or more query entities from each derived query, each of the two or more derived queries is mapped to a relevant data source of the plurality of diverse data sources based on a type of the one or more query entities in each derived query.

11. A system for multi-stage processing of a user query for enhanced information retrieval, the system comprises:
a server configured to:
generate two or more derived queries from a user search query in a split stage;
wherein each of the two or more derived queries have a length less than a first length of the user search query received originally from a client device,
and wherein two or more derived queries are independent and self-complete queries derived based on a user intent associated with the user search query;
extract one or more query entities from each derived query from the two or more derived queries;
map the one or more query entities from each derived query with a plurality of electronic documents to identify a set of relevant electronic documents for each derived query distinctly in a selection stage;
sort the two or more derived queries in a sorting stage based on a number of relevant electronic documents related to each derived query to obtain a sorted sequence of derived queries, wherein the sorted sequence of derived queries is indicative of an order in which each derived query is to be resolved;
search a result associated with each derived query in a search stage sequentially by analyzing the set of relevant electronic documents based on the sorted sequence of derived queries; and
append the result retrieved for one derived query with a consequent derived query in the sorted sequence of derived queries in a supplementing stage to obtain a final search result for the user search query.

12. The system according to claim 11, wherein in the split stage, the two or more derived queries are derived by syntactic parsing and semantic reasoning based on a self-learned weighted combination operation.

13. The system according to claim 11, wherein the two or more derived queries encompasses one or more common words or connecting words that connects the two or more derived queries to the user query.

14. The system according to claim 11, wherein in order to perform the mapping of the one or more query entities from each derived query, the server is further configured to:
create a global ontology based on information present in the plurality of electronic documents and corresponding metadata;
tag the one or more query entities in each derived query with corresponding relevant sections of information from the global ontology; and
identify the set of relevant electronic documents from the plurality of electronic documents from the plurality of diverse data sources for each query entity based on the relevant sections of information.

15. The system according to claim 14, wherein the server is further configured to train a named entity recognition (NER) model to tag the one or more query entities in each derived query with corresponding relevant sections of information from the global ontology.

16. The system according to claim 15, wherein the server is further configured to determine relevant sections of information from the global ontology based on a similarity between keywords or key phrases in the one or more query entities of each derived query and the global ontology.

17. The system according to claim 11, wherein the order in which each derived query is to be resolved is determined based on a count of lowest to highest number of relevant electronic documents related each derived query, wherein the derived query associated with the lowest number of relevant electronic documents is resolved initially followed by other derived queries.

18. The system according to claim 11, wherein the searching of the result associated with each derived query in the search stage is performed by generating a combination of database search queries for each derived query and further performing a semantic search for structured and unstructured electronic documents for each derived query.

19. The system according to claim 11, wherein in the search stage, the searching is independent of a requirement of data to follow an explicit fixed schema.

20. The system according to claim 11, wherein in the selection stage, during the mapping of the one or more query entities from each derived query, each of the two or more derived queries is mapped to a relevant data source of the plurality of diverse data sources based on a type of the one or more query entities in each derived query.
